(19) United States
(12) Patent Application Publication
(10) Pub. No.: US 2006/0235930 A1
(43) Pub. Date: Oct. 19, 2006

(54) Method to counter junk e-mail by limiting validity of e-mail addresses

(75) Inventor: Barry J. Thurlow, Luton (GB)

Correspondence Address: Marina V. Zalevsky, Esq.;FAY, SHARPE, FAGAN, MINNICH & McKEE, LLP, SEVENTH FLOOR, 1100 SUPERIOR AVENUE, CLEVELAND, OH, 44114-2579, US

(73) Assignee: XEROX CORPORATION

(21) Appl. No.: 11/109,559

(22) Filed: Apr. 19, 2005

(51) Int. Cl. G06F 15/16

(52) U.S. Cl. 709/206

(57) ABSTRACT

A restrictive e-mail system restricts the receiving of junk e-mail by limiting the validity of an e-mail address that can be used at a firewall. An arbitrary e-mail address is allocated for the e-mail directed to each recipient which is unknown to the firewall. A validity stamp is attached to each allocated arbitrary address. The validity stamp can be a recipient's identity, a recipient's e-mail address, an expiration date of the allocated random address, or an accept number of the response e-mails directed to the allocated random address. The firewall checks the validity stamp associated with each incoming e-mail and discards e-mails directed to the arbitrary addresses for which the associated validity stamps are not valid.

### BACKGROUND

The present application relates to electronic mail systems and methods. It finds particular application in conjunction with system and method to restrict sending/receiving of unsolicited electronic mail over a network. However, it is to be appreciated that the present exemplary embodiment is also amenable to other like applications.

The explosive growth of the Internet in recent years has changed classic business and economic models. Electronic mail, or “e-mail”, has become a popular way for people to communicate using networks of various types. Using e-mail, a person can send messages and other information as attachments electronically to other e-mail users. Such attachments normally include pictures, sound recordings, formatted documents, etc. that are in digital form, and which are executable independent of the opening and reading of the message included with the e-mail.

Marketing and advertising relies heavily on e-mail communications. Electronic marketing has become an attractive advertising medium for businesses and other organizations because it allows to reach large numbers of consumers at minimal cost.

However, the use of e-mail in this manner is often problematic for the recipients of such messages. On the Internet, SPAM is the term used to describe useless or unsolicited e-mail messages. Junk e-mails or SPAM are often unwanted by a computer user. Typically, the SPAM is of narrow interest. The aspiration of the “spammer” is to make a profit, even if only a small number of recipients respond. Not only is unwanted junk e-mail a nuisance to the recipient, but data processing resources which could be put to better use are devoted to processing the unwanted e-mail.

Various methods exist to filter or otherwise counter unsolicited e-mail messages. For example, filtering techniques exist to block e-mail messages received from addresses that are sources of unsolicited e-mail. One problem associated with filtering techniques, however, is that the source of the unsolicited e-mail can easily change the address to bypass the system. Another problem associated with filtering techniques is that often the legitimate bulk e-mail messages that could be of interest to the user are filtered. Moreover, filtering techniques are often ineffective against robotic delivery programs that send out thousands of junk e-mail messages and create nonexistent source addresses to prevent detection.

Another method is to form “lists” of unwanted advertisers. Such lists are often generated by users reporting unwanted e-mail to a central site which, in turn, uses filtering techniques or the like to prevent the proliferation of the unwanted email. While such “lists” are effective once the unwanted e-mail is disclosed, a problem often arises in reporting the unwanted e-mail as users are often too busy to report unwanted e-mail.

There is a need for methods and apparatuses that overcome the aforementioned problems and others.

### REFERENCES

U.S. Pat. No. 6,453,327 to Nielsen issued on Sep. 17, 2002 is directed to apparatus, methods, systems and computer program products to provide electronic mail systems with the capability for a group of trusted users to collectively determine whether a given electronic mail message is junk e-mail.

U.S. Pat. No. 6,546,416 to Kirsch issued on Apr. 8, 2003 is directed to validating the origin address of an e-mail message to enable blocking of e-mail from spam e-mail sources, by preparing, in response to the receipt of a predetermined e-mail message from an unverified source address, a data key encoding information reflective of the predetermined e-mail message.

U.S. Pat. No. 6,691,156 to Drummond et al. issued on Feb. 10, 2004 is directed to a method and computer program operative to accept e-mail for delivery to e-mail clients only if it is from an address that has been verified by an e-mail server and/or approved by a recipient.

However, these references do not discuss modifications done to the user's e-mail address sent to an unknown recipient to make the user's e-mail address unrecognizable and disposable at an expiration of the condition which is set up by the user.

### BRIEF DESCRIPTION

According to one aspect, a method of filtering electronic mail (e-mail) is disclosed. An original e-mail message to a recipient is prepared by a user on a computer. An arbitrary source address is assigned to the original e-mail message at a firewall. A validity stamp to the assigned source address is attached at the firewall. Based on the validity stamp, response e-mails directed to the arbitrary source address are sorted at the firewall to restrict unwanted e-mails from reaching the user.

According to another aspect, a spam filtering system is disclosed. Original e-mail messages directed to recipients are prepared on computers. A firewall assigns an arbitrary source address to each original e-mail message directed to a recipient being unknown to the firewall. A validity stamp is attached to the assigned arbitrary source address by the firewall. A filtering mechanism, based on the validity stamp, sorts response e-mails directed to the assigned arbitrary source address to restrict unwanted e-mails from reaching the user.

### BRIEF DESCRIPTION OF THE DRAWINGS

FIG. 1 is a diagrammatic illustration of a client server system;

FIG. 2 is a flow chart illustrating a portion of a restrictive mailing system;

FIG. 3 is an illustration of a user interface screen; and

FIG. 4 is a flow chart illustrating another portion of the restrictive mailing system.

### DETAILED DESCRIPTION

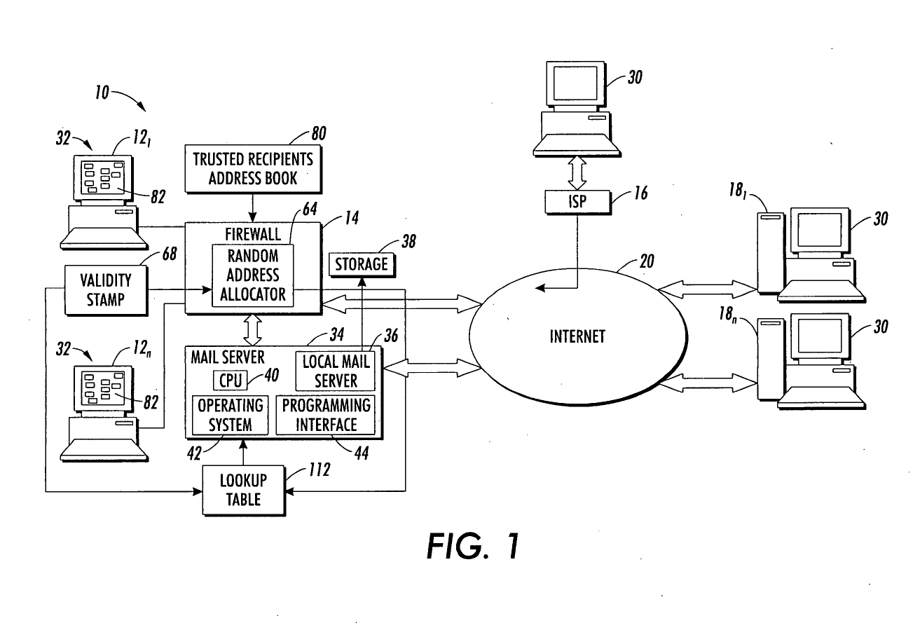

With reference to FIG. 1, an Internet client-server system 10 includes a set of client machines 12₁, . . . , 12ₙ which are connected within a firewall or firewall function 14 within an enterprise environment. The firewall 14, for example, can be a separate unit of hardware and software, a separate software on the client machine, part of the e-mailing system, or any other appropriate device. As another example, the firewall 14 can be the firewall server that connects all of the user computers of one organization unto the Internet. As another example, the firewall function 14 can be performed by an ISP 16, or Internet service provider, such as Yahoo. Each client machine 12₁, . . . , 12ₙ has the capability of connecting to a set of web servers 18₁, . . . , 18ₙ over a network 20 in a known manner. Network 20 typically includes other servers for control of domain name resolution, routing and other control functions. The network 20 can be an Intranet, Internet, or any other known network. Each client machine 12₁, . . . , 12ₙ typically includes a set of programs that enable a user of the client machine 12₁, . . . , 12ₙ to obtain known Internet services including one-to-one messaging (e-mail), one-to-many messaging (bulletin board), file transfer, web browsing, and other. Thus, the user of a client machine 30 outside the firewall 14 may communicate with one of the clients 12₁, . . . , 12ₙ inside the firewall 14.

For example, the client machine 12₁, . . . , 12ₙ can be a personal computer, notebook computer, Internet appliance or pervasive computing device (e.g., a PDA or palm computer) that is x86-, Pentium-PowerPC®- or RISC-based. Each client machine 12₁, . . . , 12ₙ includes an operating system, for example, IBM® OS/2®, Microsoft Windows, Microsoft Windows NT, Windows CE, PalmOS, and the like. Each client machine 12₁, . . . , 12ₙ includes a suite of Internet tools including, for example, a Web browser, such as Netscape Navigator or Microsoft Internet Explorer, that has a Java Virtual Machine (JVM) and support for application plug-ins or helper applications.

Each client machine 12₁, . . . , 12ₙ includes a Simple Mail Transport Protocol (SMTP) e-mail client 32 such as Lotus Notes, Microsoft Outlook, or the like. E-mail clients 32 cooperate with a mail server 34 in a known manner. For example, the mail server 34 can be an IBM Domino server comprising a processor or CPU 40, an operating system 42 and a local mail server 36. The mail server 34 can also include an Application Programming Interface (API) 44 that provides extensions to enable application developers to extend and/or customize the core functionality of the system 10 through software programs including plug-ins, servlets, and the like. The local mail server 36 stores incoming e-mail on a local storage system 38 and delivers the mail to an end user (e.g., via POP, IMAP or a command line program). In the Internet paradigm, a network path to a resource (e.g., a server) is identified by a so-called Uniform Resource Locator (URL).

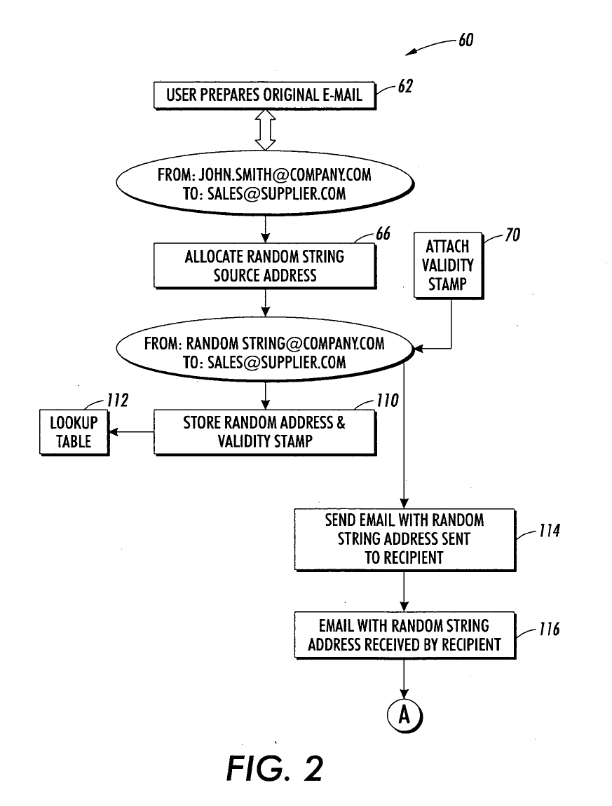

With continuing reference to FIG. 1 and further reference to FIG. 2, a restrictive e-mail system 60 effectively blocks the receiving of junk e-mail or SPAM by limiting the validity of an e-mail address that can be used within the client-server system 10. More specifically, the user prepares 62 an original e-mail message to a recipient on the client machine 12₁, . . . , 12ₙ. For example, the prepared e-mail can be from john.smith@company.com. Such personal e-mail address is a typical personal e-mail address which includes a combination of a sender's name and a company name, which indicates the sender's association with the employer. The recipient of the original e-mail, for example, is from the Sales Department and has an address sales@supplier.com. The firewall 14 includes a random address allocator 64 which allocates 66 an arbitrary or random source address for the original e-mail message. Such allocated arbitrary address comprises a random string of characters, for example, at least about 128 characters long. At the same time, a validity stamp 68 is attached 70 to the allocated arbitrary source address. The validity stamp 68 can be a recipient's identity, a recipient's e-mail address, an expiration date of the assigned source address, an accept number of the response e-mails directed to the allocated source address, and the like.

In one embodiment, a user creates a trusted recipients address book 80. The firewall 14 looks up the trusted recipient address book 80 and determines whether the recipient of the original e-mail, e.g. sales@suppier.com is a known recipient. If the recipient is an unknown recipient, then the random address allocator 64 assigns 66 an arbitrary source address to the original e-mail. If the recipient is a known recipient, the arbitrary address is not assigned to the original e-mail. In this manner, a new random address is used every time the user sends an e-mail to an unknown recipient. Any recipient outside the firewall 14 does not know the user's personal e-mail address or user's random e-mail addresses that are used in sending e-mails to other recipients. E-mail sent to a multiplicity of recipients such as in a distribution list uses different random names for each recipient.

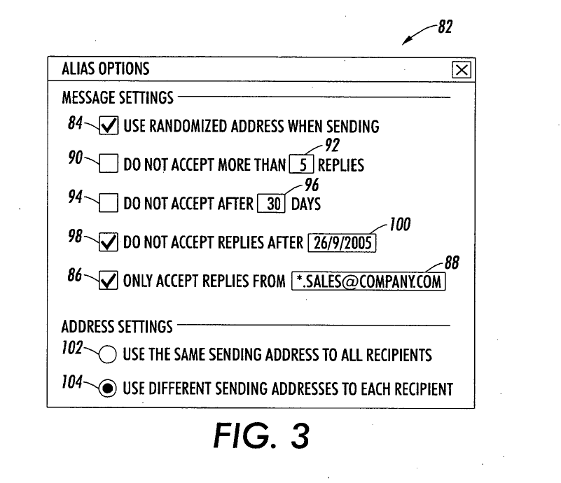

With continuing reference to FIGS. 1 and 2 and further reference to FIG. 3, the user is directed to set up his or her preferences for a use of the validity stamp 68 in future e-mails. More specifically, the client machine 12₁, . . . , 12ₙ includes an interactive user interface module or screen 82 which directs the user to make his or her preferences when creating the validity stamp 68. More specifically, the screen 82 includes a first field 84 which the user clicks if a use of the random address is desired. For instance, the user can choose the validity stamp 68 to be the recipient's identity by clicking a second field 86. For example, the user can set up the validity stamp 68 to only accept replies from *.sales@company.com by filling in a name field 88 to allow replies from anyone whose e-mail name ends with .sales and who is in the organization “company.” Thus, a reply from someone from the Sales Department with the names in the form jane.sales@company.com would be accepted by the firewall 14. As another example, the user can specify to accept only replies from *@company.com, which would allow anyone in the recipient's organization to reply. As another example, the user can specify the number of times the e-mail from a particular recipient can be accepted at the firewall 14. The user clicks on a third field 90 and enters a desired number of times the e-mail is to be accepted in a number of times field 92. As another example, the user can specify the number of days beyond which the e-mail from a particular recipient cannot be accepted at the firewall 14. The user clicks on a fourth field 94 and enters a desired number of days in a number of days field 96. As another example, the user can specify an expiration date of the assigned source address, beyond which the e-mails from the particular recipient are discarded and the assigned source address is invalid. The user clicks on a fifth field 98 and enters a desired date in a date field 100. As seen in FIG. 3, the user has a choice of using the same random address for all or some of the originating e-mails. For example, the user selects to use the same source address by clicking on a sixth field 102 for all recipients whose names end with *.sales@company.com. Otherwise, as a default in one embodiment, the interface screen 82 pops up with a selection of using different source addresses each time the e-mail is sent by the user to an unknown recipient as indicated by a selection of a seventh field 104.

In one embodiment, the interactive user interface screen 82 pops up every time the user sends the e-mail. The interactive user interface screen 82 directs the user to select his or her preferred validity stamp 68 for the particular e-mail.

The allocated arbitrary source addresses are stored 110 in a look-up table 112. The look-up table 112 includes the arbitrary source addresses assigned to each user and validity stamps 68 associated with each assigned source address. The e-mail with the arbitrary source address is sent 114 to the recipient and finally is received 116 by the recipient.

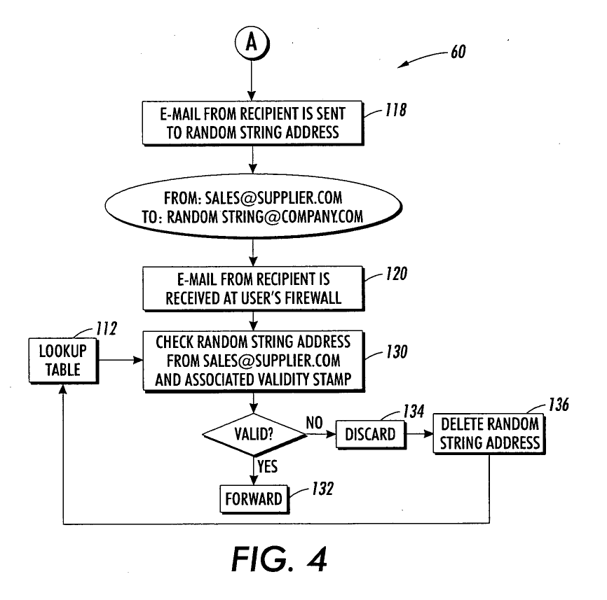

With reference to FIG. 4, a reply e-mail from the recipient is sent 118 to the arbitrary source address and consequently received 120 at the firewall 14.

The firewall 14 checks 130 the look-up table 112 to verify the arbitrary source address and the associated validity stamp 68. If the validity stamp 68 and the arbitrary source address are valid, the firewall 14 forwards 132 the e-mail to the user. If the firewall 14 determines that the validity stamp 68 is not valid, the recipient's reply e-mail is discarded 134. If the validity stamp 68, for example, is the expiration date of the assigned arbitrary source address or the accept number of the response e-mails directed to the assigned arbitrary source address, the arbitrary source address is deleted 136 from the look-up table 112 after expiration of such validity stamps. Such random e-mail address, which disappears after a short period of time or a small number of uses, protects the user from receiving an unwanted e-mail and also makes the sending of SPAM uneconomical, thus discouraging the senders of SPAM from continuing the trade. By the time a spammer discovers such randomized e-mail addresses, most of the randomized addresses are timed out or of no value. The whole concept of sending SPAM e-mails would eventually disappear.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of filtering electronic mail (e-mail) comprising:
preparing, by a user, an original e-mail message to a recipient on a computer;
assigning an arbitrary source address to the original e-mail message at a firewall;
attaching a validity stamp to the assigned source address at the firewall; and
based on the validity stamp, sorting response e-mails directed to the arbitrary source address at the firewall to restrict unwanted e-mails from reaching the user.

2. The method as set forth in claim 1, further including:
assigning a new arbitrary address to each e-mail message directed to a recipient which is unknown to the firewall.

3. The method as set forth in claim 1, wherein the assigned arbitrary address comprises a random string of characters.

4. The method as set forth in claim 3, wherein the string of characters is at least about 128 characters long.

5. The method as set forth in claim 1, wherein the validity stamp is at least one of:
recipient identity;
recipient address;
an expiration date of the assigned source address; and
an accept number of the response e-mails directed to the assigned source address.

6. The method as set forth in claim 5, further including:
selecting by the user at least one validity stamp via an interactive user interface module.

7. The method as set forth in claim 5, wherein the sorting includes:
accepting the response e-mails, which satisfy the validity stamp; and
discarding the response e-mails, which do not satisfy the validity stamp.

8. The method as set forth in claim 1, wherein the firewall is at least one of:
a local network server for a network of computer including the computer;
a spam firewall for a network of computers including the computer;
a public network server; and
a software module associated with the computer.

9. The method as set forth in claim 1, further including:
generating a look up table which at least includes:
the arbitrary source addresses assigned to each user, and
validity stamps associated with each assigned arbitrary source address.

10. The method as set forth in claim 9, further including:
deleting the arbitrary source addresses with the associated expired validity stamp.

11. The method as set forth in claim 1, further including:
generating an address book of trusted recipients; and
assigning the arbitrary source addresses only to the recipients excluded from the trusted recipients address book.

12. A spam filtering system comprising:
computers, on which original e-mail messages directed to recipients, are prepared;
a firewall which assigns an arbitrary source address to each original e-mail message directed to a recipient being unknown to the firewall;
a validity stamp which is attached to each assigned arbitrary source address by the firewall; and
a filtering mechanism, which, based on the validity stamp, sorts response e-mails directed to the assigned arbitrary source address, to restrict unwanted e-mails from reaching the user.

13. The system as set forth in claim 12, wherein the assigned arbitrary address comprises a random string of characters.

14. The system as set forth in claim 13, wherein the string of characters is at least about 128 characters long.

15. The system as set forth in claim 12, wherein the validity stamp is at least one of:
recipient identity;
recipient address;
an expiration date of the assigned source address; and
an accept number of the response e-mails directed to the assigned arbitrary source address.

16. The system as set forth in claim 15, further including:
an interactive user interface module, via which the user selects at least one validity stamp to be attached to the assigned arbitrary source address.

17. The system as set forth in claim 12, wherein the firewall is at least one of:
a local network server for a network of computer including the computer;
a spam firewall for a network of computers including the computer;
a public network server; and
a software module associated with the computer.

18. The system as set forth in claim 12 further including:
a look up table which at least includes:
the arbitrary source addresses assigned to each user, and
the validity stamps associated with each assigned arbitrary source address.

19. The system as set forth in claim 12, further including:
an address book of trusted recipients, from which the server determines known and unknown recipients.
